(19) United States
(12) Patent Application Publication
(10) Pub. No.: US 2019/0079663 A1
(43) Pub. Date: Mar. 14, 2019

(54) SCREENSHOT METHOD AND SCREENSHOT APPARATUS FOR AN ELECTRONIC TERMINAL

(71) Applicant: Samsung Electronics Co., Ltd., Suwon-si (KR)

(72) Inventors: Feifei WANG, Tianjin (CN); Minglei RUAN, Tianjin (CN); Hui TIAN, Tianjin (CN)

(21) Appl. No.: 15/704,700

(22) Filed: Sep. 14, 2017

(51) Int. Cl. G06F 3/0488; G06F 3/0484; G06F 9/44

(52) U.S. Cl. CPC G06F 3/04883; G06F 3/04842; G06K 9/00013; G06F 9/4443; G06F 3/04845

(57) ABSTRACT

A screenshot method and screenshot apparatus for an electronic terminal are provided. The screenshot method for an electronic terminal includes receiving a biometric feature signal, sensing a sliding track formed by a sliding operation on a display area of the electronic terminal during a period when the biometric feature signal is inputted, and intercepting an image surrounded by the sliding track. With the above screenshot method and apparatus for an electronic terminal, screenshots can be performed quickly, based on the combination of a biometric feature and the sliding operation, and thus the experience of user can be improved.

### TECHNICAL FIELD

The present disclosure relates to a field of electronic technology. More particularly, the present disclosure relates to a screenshot method and screenshot apparatus for an electronic terminal.

### BACKGROUND

In an electronic terminal, screenshot is a function with high utilization, and many of the related-art screenshot implementations are convenient for users, for example, full-screen screenshots, part-screen screenshots, user-defined screenshots and so on.

However, the procedures to carry out the related-art screenshot implementations are cumbersome, and require a user to make complex inputs for the screenshot, which is inconvenient to the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a screenshot method and screenshot apparatus for an electronic terminal to address the technical problems of the related-art screenshot due to the operations to carry out the related-art screenshot being complicated and tedious.

In accordance with an aspect of the present disclosure, a screenshot method for an electronic terminal is provided. The method includes receiving a biometric feature signal, sensing a sliding track formed by a sliding operation on a display area of the electronic terminal during a period when the biometric feature signal is inputted, and intercepting an image surrounded by the sliding track.

Alternately, the sensing of the sliding track comprises determining whether a biometric feature represented by the received biometric feature signal corresponds to a predetermined feature representation, wherein, in the operation (B), the sliding track formed by the sliding operation on the display area of the electronic terminal is sensed when the biometric feature represented by the received biometric feature signal corresponds to the predetermined feature representation.

Alternately, the predetermined feature representation may comprise at least one of a fingerprint feature representation or a heart rate feature representation.

Alternately, the intercepting of the image surrounded by the sliding track may further comprise determining whether a curve formed by the sliding track is a closed curve, wherein, when the curve formed by the sliding track is a closed curve, an image surrounded by the closed curve is intercepted.

Alternately, the intercepting of the image surrounded by the closed curve may comprise controlling the electronic terminal to enter a selection editing interface when the curve formed by the sliding track is a closed curve, receiving an input on a screen of the electronic terminal for the closed curve from a user, adjusting a position and a shape of the closed curve according to the received input, intercepting an image surrounded by the closed curve on the screen of the electronic terminal.

Alternately, the method may further comprise controlling the electronic terminal to enter an image editing interface and edit the intercepted image according to an interactive input of a user on the image editing interface.

In accordance with another aspect of the present disclosure, an electronic terminal is provided. The method includes an input device configured to receive a biometric feature signal, a sensor configured to sense a sliding track formed by a sliding operation on a display area of the electronic terminal during a period when the biometric feature signal is inputted, and a processor configured to intercept an image surrounded by the sliding track.

Alternately, the sensor further determines whether a biometric feature represented by the received biometric feature signal corresponds to a predetermined feature representation, wherein the sensor sense the sliding track formed by the sliding operation on the display area of the electronic terminal when the biometric feature represented by the received biometric feature signal corresponds to the predetermined feature representation.

Alternately, the predetermined feature representation comprises at least one of a fingerprint feature representation or a heart rate feature representation.

Alternately, the processor is configured to determine whether a curve formed by the sliding track is a closed curve, wherein, when the curve formed by the sliding track is a closed curve, the processor is configured to intercept an image surrounded by the closed curve.

Alternately, the processor is configured to control the electronic terminal to enter a selection editing interface when the curve formed by the sliding track is a closed curve, control to receive an input on a screen of the electronic terminal for the closed curve from the user, adjust a position and a shape of the closed curve according to the received input and, intercept an image surrounded by the closed curve on the screen of the electronic terminal.

Alternately, the processor is configured to, after the image surrounded by the sliding track is intercepted, control the electronic terminal to enter an image editing interface, and edit the intercepted image according to an interactive input of a user on the image editing interface.

With the above screenshot method and screenshot apparatus for an electronic terminal, screenshots can be performed quickly, based on the combination of the biometric feature and the sliding operation, and thus the experience of user can be improved.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a flowchart of a screenshot method for an electronic terminal according to an embodiment of the present disclosure;

FIG. 2 illustrates a flowchart of the operation of intercepting an image surrounded by a closed curve formed by a sliding track in FIG. 1 according to an embodiment of the present disclosure;

FIG. 3 illustrates an example diagram of intercepting an image on an electronic terminal using the screenshot method described in FIG. 1 according to an embodiment of the present disclosure;

FIG. 4 illustrates a block diagram of a screenshot apparatus for an electronic terminal according to an embodiment of the present disclosure; and

FIG. 5 illustrates a structure diagram of a screenshot unit in FIG. 4 according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

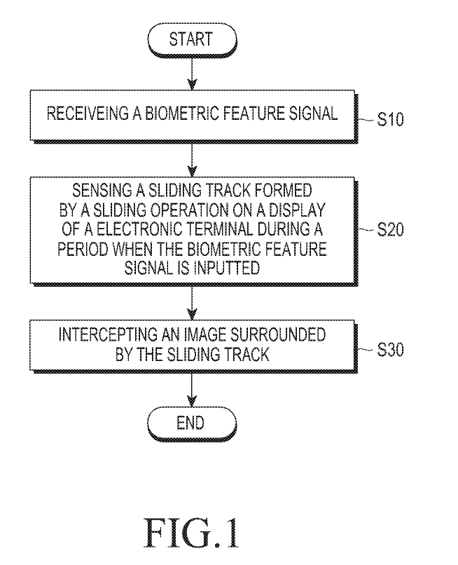

FIG. 1 illustrates a flowchart of a screenshot method for an electronic terminal according to an embodiment of the present disclosure. Here, as an example, the electronic terminal may be an electronic device having a touch screen, such as a smartphone, a tablet computer, a game machine, a personal digital assistant, or the like.

Referring to FIG. 1, a biometric feature signal is received in operation S10. Here, the biometric feature signal may be received when the electronic terminal is in a locked state, an unlocked state, a state of transiting from a locked state to an unlocked state, or a state of transiting from an unlocked state to a locked state. In the unlocked state, a screen of the electronic terminal displays a user interface or an operation interface of an application.

Preferably, the electronic terminal may comprise a biometric feature signal sensor through which the biometric feature signal is received. As an example, the biometric feature signal sensor may include a fingerprint reader or a heart rate sensor that may be disposed on at least one of a front surface, a rear surface, or a side surface of the electronic terminal, preferably, the biometric feature signal sensor may be disposed on the front surface of the electronic terminal (e.g., the HOME key).

In operation S20, a sliding track formed by a sliding operation on the screen of the electronic terminal is sensed during a period when the biometric feature signal is inputted.

In one case, it is not necessary to verify the biometric feature signal received in operation S10. In this case, as long as the biometric feature signal is received, the sliding track formed by the sliding operation on the screen of the electronic terminal is sensed during the period when the biometric feature signal is inputted.

In another case, it is necessary to verify the biometric feature signal received in operation S10.

For example, the verifying of the received biometric feature signal may include determining whether a biometric feature represented by the received biometric feature signal corresponds to a predetermined feature representation, and when the biometric feature represented by the received biometric feature signal corresponds to the predetermined feature representation, the sliding track formed by the sliding operation on the screen of the electronic terminal is sensed during the period when the biometric feature signal is inputted. As an example, the predetermined feature representation may include at least one of a fingerprint feature representation or a heart rate feature representation.

In one example, the predetermined feature representation may refer to a representation of the laws of a predetermined biometric feature.

For example, the electronic terminal only needs to determine whether the biometric feature represented by the received biometric feature signal is a fingerprint of a human finger or whether the biometric feature represented by the received biometric feature signal is a human heart rate, and in this case, it does not need to determine the detailed ownership of the biometric feature represented by the received biometric feature signal (i.e., there is no need to determine which user the biometric feature represented by the received biometric feature signal belongs to), so the time for feature recognition is short and the possibility of misidentification is also low.

However, the present disclosure is not limited thereto, and in another example, the predetermined feature representation may refer to a biometric feature of a predetermined user stored in advance.

For example, whether the biometric feature represented by the received biometric feature signal matches the biometric feature of the predetermined user may be determined, and when the biometric feature represented by the received biometric feature signal coincides with the biometric feature of the predetermined user, the sliding track formed by the sliding operation on the screen of the electronic terminal is sensed during the period when the biometric feature signal is inputted. When the biometric feature represented by the received biometric feature signal does not coincide with the biometric feature of the predetermined user, the sliding track formed by the sliding operation on the screen of the electronic terminal is not sensed during the period when the biometric feature signal is inputted.

In operation S30, an image surrounded by the sliding track is intercepted.

Preferably, it is determined in operation S30 whether a curve formed by the sliding track is a closed curve, and when the curve formed by the sliding track is a closed curve, an image surrounded by the closed curve is intercepted.

In a preferred example, after determining that the curve formed by the sliding track is a closed curve, a position and a shape of the closed curve can be edited according to an input of the user, so that an image surrounded by the adjusted closed curve is the image to be intercepted by the user.

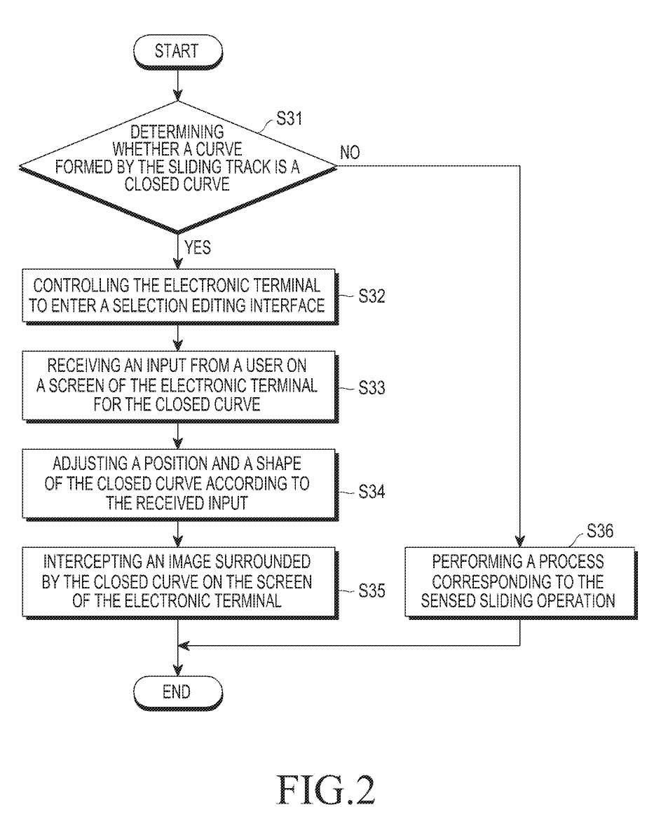

The operation of intercepting the image surrounded by the closed curve will be described in detail with reference to FIG. 2.

FIG. 2 illustrates a flowchart of the operation of intercepting the image surrounded by the closed curve formed by the sliding track in FIG. 1 according to an embodiment of the present disclosure.

Referring to FIG. 2, in operation S31, it is determined whether the curve formed by the sliding track is a closed curve.

When the curve formed by the sliding track is a closed curve, the operation S32 is performed. That is, the electronic terminal is controlled to enter a selection editing interface. Here, the selection editing interface may be any one of existing interfaces for editing a position and a shape of the closed curve, and the present disclosure is not limited thereto.

In the operation S33, an input from user on the screen of the electronic terminal for the closed curve is received. As an example, the input may be a touch input.

In the operation S34, the position and the shape of the closed curve is adjusted according to the received input, so that an image surrounded by the closed curve of which the position and the shape are adjusted is an image to be intercepted by the user.

In the operation S35, the image surrounded by the closed curve on the screen of the electronic terminal is intercepted.

When the curve formed by the slide track is not a closed curve, the operation S36 is performed, That is, the electronic terminal senses the sliding operation forming the slide track, and performs a process corresponding to the sensed sliding operation.

For example, assuming that the screen of the electronic terminal displays a user interface (or an interface for browsing the picture, etc.) currently, in this case, if the curve formed by the sliding track is not a closed curve, a direction of the sensed sliding operation on the screen of the electronic terminal may be detected and the electronic terminal is controlled to switch pages according to the direction.

In addition, if the interface currently displayed on the screen of the electronic terminal cannot be switched according to the sensed sliding operation, the electronic terminal does not respond to the sensed sliding operation on the screen of the electronic terminal.

Here, it is preferable that, after the image surrounded by the sliding track is intercepted, the intercepted image may be further edited according to an operation of user, or the intercepted image may be applied according to an operation of user (for example, the intercepted image may be set as the contact avatar, the intercepted image may be shared to the social network, etc.

Alternately, the editing of the intercepted image according to the operation of user may include controlling the electronic terminal to enter the image editing interface, after the image surrounded by the sliding track is intercepted, and editing the intercepted image according to an interactive input from user on the image editing interface. Here, the image editing interface may be any one of existing interfaces for editing an image, and the present disclosure is not limited thereto.

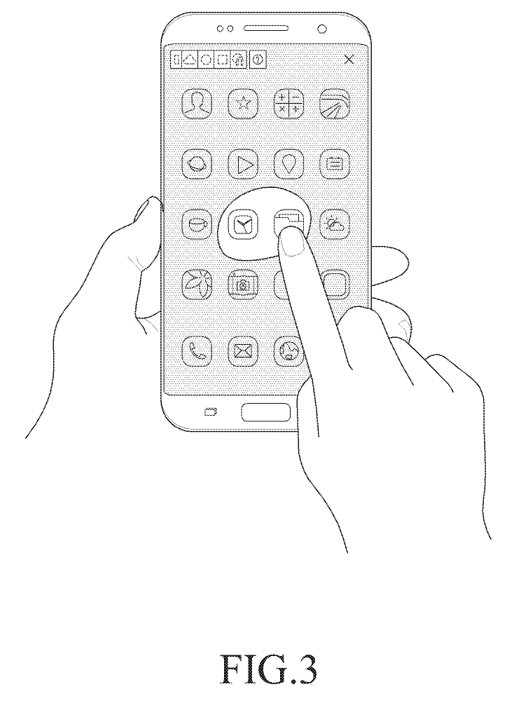

The application procedure of the screenshot method for an electronic terminal according to the embodiment of the present disclosure will be described below with reference to FIG. 3.

FIG. 3 illustrates an example diagram of intercepting an image on an electronic terminal using the screenshot method described in FIG. 1 according to an embodiment of the present disclosure.

Referring to FIG. 3, a screenshot method of an embodiment of the present disclosure is described with the fingerprint identification as an example, for example, the screen of the electronic terminal displays a user interface, a fingerprint reader, through which the biometric feature signal is received, is set below the front surface of the electronic terminal (e.g. the HOME key), and when it is determined that the biometric feature represented by the received biometric feature signal corresponds to a fingerprint feature representation (i.e., it is determined that the biometric feature represented by the received biometric feature signal is a human fingerprint), the sliding track formed by the sliding operation on the display area of the electronic terminal is sensed during the period when the biometric feature signal is inputted.

Preferably, in the present example, it is assumed that the operating habits of user are with the right hand, here, the user can hold the electronic terminal with his left hand and place the thumb of the left hand on the fingerprint reader so that the biometric feature signal is received by the fingerprint reader, and the sliding operation performed by the right hand of user on the display area of the electronic terminal is sensed during the period when the biometric feature signal is inputted. The above operation mode is more suitable with the operating habits of user so as to facilitate the user to take a screenshot.

After the sliding track formed by the sliding operation on the display area of the electronic terminal (for example, the sliding track formed by the sliding operation by the index finger of right hand of the user on the screen of the electronic terminal) is sensed, whether the curve formed by the sliding track is a closed curve is determined. If the curve is a closed curve, the image surrounded by the closed curve is intercepted, and if not, the direction of the sliding operation forming the sliding track is detected (for example, the detected direction of the sliding operation may be a direction from right to left), and accordingly, the electronic terminal can be controlled to page left.

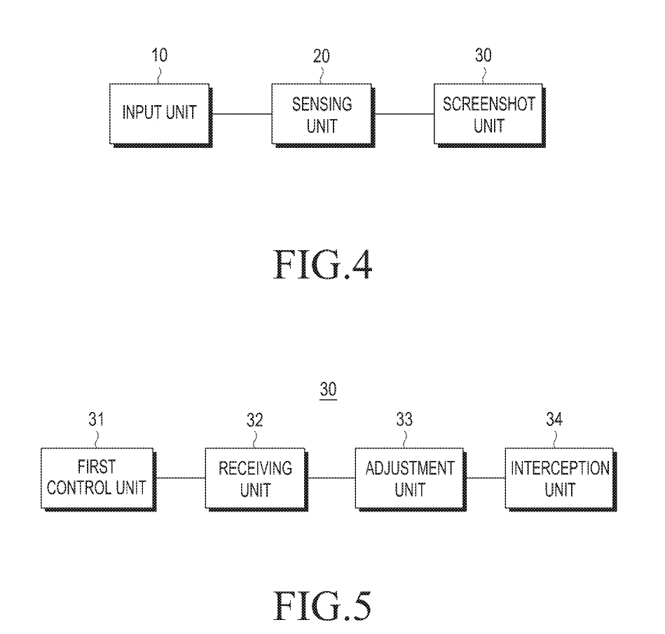

FIG. 4 illustrates a block diagram of a screenshot apparatus for an electronic terminal according to an embodiment of the present disclosure.

Referring to FIG. 4, a screenshot apparatus for an electronic terminal according to an embodiment of the present disclosure may include an input unit 10, a sensing unit 20 and a screenshot unit 30. Here, as an example, the electronic terminal may be an electronic apparatus having a touch screen, such as a smartphone, a tablet computer, a game machine, a personal digital assistant, or the like.

In particular, the input unit 10 receives a biometric feature signal. Here, the input unit 10 may receive the biometric feature signal when the electronic terminal is not in a state under which the electronic terminal is locked, that is, when the electronic terminal is in a state after unlocking (for example, in the case where a screen of the electronic terminal displays a user interface or an operation interface of an application).

Preferably, the input unit 10 may be a biometric feature signal sensor through which the biometric feature signal is received. As an example, the biometric feature signal sensor may include a fingerprint reader or a heart rate sensor that may be disposed on a front surface, a rear surface or a side surface of the electronic terminal, preferably, the biometric feature signal sensor may be disposed on the front surface of the electronic terminal (e.g., the HOME key).

The sensing unit 20 senses a sliding track formed by the sliding operation on the display area of the electronic terminal during a period when the biometric feature signal is inputted.

In one case, the sensing unit 20 does not need to verify the biometric feature signal received by the input unit 10. In this case, as long as the biometric feature signal is received, the sensing unit 20 senses the sliding track formed by the sliding operation on the screen of the electronic terminal during the period when the biometric feature signal is inputted.

In another case, the sensing unit 20 needs to verify the biometric feature signal received by the input unit 10.

For example, the sensing unit 20 may determine whether a biometric feature represented by the received biometric feature signal corresponds to a predetermined feature representation, and when the biometric feature represented by the received biometric feature signal corresponds to the predetermined feature representation, the sensing unit 20 senses the sliding track formed by the sliding operation on the screen of the electronic terminal during the period when the biometric feature signal is inputted. As an example, the predetermined feature representation may include at least one of a fingerprint feature representation or a heart rate feature representation.

In one example, the predetermined feature representation may refer to a representation of the laws of a predetermined biometric feature.

For example, the sensing unit 20 may only determine whether the biometric feature represented by the received biometric feature signal is a fingerprint of a human finger or whether the biometric feature represented by the received biometric feature signal is a human heart rate, and in this case, it does not need to determine the detailed ownership of the biometric feature represented by the received biometric feature signal (i.e., there is no need to determine which user the biometric feature represented by the received biometric feature signal belongs to), so the time for feature recognition is short and the possibility of misidentification is also low.

However, the present disclosure is not limited thereto, and in another example, the predetermined feature representation may refer to a biometric feature of a predetermined user stored in advance.

For example, the sensing unit 20 may determine whether the biometric feature represented by the received biometric feature signal matches the biometric feature of the predetermined user (i.e., determine the detailed ownership of the biometric feature represented by the received biometric feature signal), when the biometric feature represented by the received biometric feature signal coincides with the biometric feature of the predetermined user, the sensing unit 20 senses the sliding track formed by the sliding operation on the screen of the electronic terminal during the period when the biometric feature signal is inputted. When the biometric feature represented by the received biometric feature signal does not coincide with the biometric feature of the predetermined user, the sensing unit 20 does not sense the sliding track formed by the sliding operation on the screen of the electronic terminal during the period when the biometric feature signal is inputted.

The screenshot unit 30 intercepts an image surrounded by the sliding track.

Preferably, the screenshot apparatus according to an embodiment of the present disclosure may further include a determination unit configured to determine whether a curve formed by the slide track is a closed curve, and when the curve formed by the slide track is a closed curve, the screenshot unit 30 intercepts an image surrounded by the closed curve.

Also, the screenshot apparatus according to the embodiment of the present disclosure may further include an execution unit configured to perform the process corresponding to the sensed sliding operation forming the sliding track.

For example, assuming that the screen of the electronic terminal displays a user interface (or an interface for browsing the picture, etc.) currently, in this case, if the curve formed by the sliding track is not a closed curve, the execution unit may detect a direction of the sensed sliding operation on the screen of the electronic terminal and control the electronic terminal to switch pages according to the direction. In addition, if the interface currently displayed on the screen of the electronic terminal cannot be switched according to the sensed sliding operation, the electronic terminal does not respond to the sensed sliding operation on the screen of the electronic terminal.

In a preferred example, after the determination unit determining that the curve formed by the sliding track is a closed curve, the screenshot unit 30 may edit a position and a shape of the closed curve according to the input of user, such that the image surrounded by the adjusted closed curve is the image to be intercepted by the user.

Below, the process of the intercepting unit 30 for intercepting the image surrounded by the closed curve will be described in detail with reference to FIG. 5.

FIG. 5 illustrates a structure diagram of the screenshot unit in FIG. 4 according to an embodiment of the present disclosure.

Referring to FIG. 5, the screenshot unit according to an embodiment of the present disclosure may include a first control unit 31, a receiving unit 32, an adjustment unit 33 and an interception unit 34.

Specifically, the first control unit 31 controls the electronic terminal to enter an selection editing interface when the curve formed by the sliding track is a closed curve. Here, the selection editing interface may be any one of existing interfaces for editing a position and a shape of the closed curve, and the present disclosure is not limited thereto.

The receiving unit 32 receives an input from user on the screen of the electronic terminal for the closing curve. As an example, the input may be a touch input.

The adjustment unit 33 adjusts the position and the shape of the closed curve according to the received input, so that an image surrounded by the closed curve of which the position and the shape are adjusted is the image to be intercepted by the user.

The interception unit 34 intercepts the image surrounded by the closed curve on the screen of the electronic terminal.

Herein, it is preferable that the screenshot apparatus according to an embodiment of the present disclosure may further include a second control unit configured to, after the image surrounded by the sliding track is intercepted, control the electronic terminal to enter an image editing interface, and edit the intercepted image according to the interactive input from user on the image editing interface.

Alternately, after the image surrounded by the sliding track is intercepted, the second control unit may control the electronic terminal to enter an image editing interface and edit the intercepted image according to the interactive input from user on the image editing interface. Here, the image editing interface may be any one of existing interfaces for editing an image, and the present disclosure is not limited thereto.

Furthermore, the screenshot apparatus according to an embodiment of the present disclosure may further include an image application unit configured to apply the intercepted image according to an operation of user (for example, set the intercepted image as the contact avatar, share the intercepted image to the social network, etc).

With the above screenshot method and the screenshot apparatus for an electronic terminal according to the embodiment of the present disclosure, screenshots can be performed quickly, based on the combination of the biometric feature and the sliding operation, and thus the experience of user can be improved.

In addition, it should be understood that the various units in the screenshot apparatus for an electronic terminal according to the embodiment of the present disclosure may be implemented as hardware components. Those skilled in the art can use for example field programmable gate arrays (FPGAs) or application specific integrated circuits (ASICs) to implement respective units according to the process performed by each limited unit. Alternatively or additionally, it should be understood that any combination of the various units in the screenshot apparatus for an electronic terminal according to the embodiment of the present disclosure may be implemented as software executed on at least one processor of the electronic terminal.

In addition, the screenshot method for the electronic terminal according to an embodiment of the present disclosure may be implemented as computer code in a non-transitory computer readable recording medium. Those skilled in the art can implement the computer code according to the description of the method described above. The above method of the present disclosure is implemented when the computer code is executed in a computer.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A screenshot method for an electronic terminal, the screenshot method comprising:
receiving a biometric feature signal;
sensing a sliding track formed by a sliding operation on a display area of the electronic terminal during a period when the biometric feature signal is inputted; and
intercepting an image surrounded by the sliding track.

2. The screenshot method of claim 1, wherein the sensing of the sliding track comprises:
determining whether a biometric feature represented by the received biometric feature signal corresponds to a predetermined feature representation,
wherein the sliding track formed by the sliding operation on the display area of the electronic terminal is sensed when the biometric feature represented by the received biometric feature signal corresponds to the predetermined feature representation.

3. The screenshot method of claim 2, wherein the predetermined feature representation comprises at least one of a fingerprint feature representation or a heart rate feature representation.

4. The screenshot method of claim 1, wherein the intercepting of the image surrounded by the sliding track comprises:
determining whether a curve formed by the sliding track is a closed curve,
wherein, when the curve formed by the sliding track is a closed curve, an image surrounded by the closed curve is intercepted.

5. The screenshot method of claim 4, wherein the intercepting of the image surrounded by the closed curve comprises:
controlling the electronic terminal to enter a selection editing interface when the curve formed by the sliding track is a closed curve;
receiving an input on a screen of the electronic terminal for the closed curve from a user;
adjusting a position and a shape of the closed curve according to the received input; and
intercepting an image surrounded by the closed curve on the screen of the electronic terminal.

6. The screenshot method of claim 1, further comprising: controlling the electronic terminal to enter an image editing interface and edit the intercepted image according to an interactive input of a user on the image editing interface.

7. An electronic terminal, the electronic terminal comprising:
an input device configured to receive a biometric feature signal;
a sensor configured to sense a sliding track formed by a sliding operation on a display area of the electronic terminal during a period when the biometric feature signal is inputted; and
a processor configured to intercept an image surrounded by the sliding track.

8. The electronic terminal of claim 7, wherein the sensor further determines whether a biometric feature represented by the received biometric feature signal corresponds to a predetermined feature representation,
wherein the sensor senses the sliding track formed by the sliding operation on the display area of the electronic terminal when the biometric feature represented by the received biometric feature signal corresponds to the predetermined feature representation.

9. The electronic terminal of claim 8, wherein the predetermined feature representation comprises at least one of a fingerprint feature representation or a heart rate feature representation.

10. The electronic terminal of claim 7, wherein the processor is configured to determine whether a curve formed by the sliding track is a closed curve,
wherein, when the curve formed by e sliding track is a closed curve, the processor is configured to intercept an image surrounded by the closed curve.

11. The electronic terminal of claim 10, wherein the processor is configured to:
control the electronic terminal to enter a selection editing interface when the curve formed by the sliding track is a closed curve;
control to receive an input on a screen of the electronic terminal for the closed curve from the user;
adjust a position and a shape of the closed curve according to the received input; and
intercept an image surrounded by the closed curve on the screen of the electronic terminal.

12. The electronic terminal of claim 7, wherein the processor is configured to, after the image surrounded by the sliding track is intercepted, control the electronic terminal to enter an image editing interface, and edit the intercepted image according to an interactive input of a user on the image editing interface.

13. The electronic terminal of claim 7, wherein the input device comprises one of a fingerprint reader or a heart rate sensor.

14. The electronic terminal of claim 7, wherein the input device is disposed on a front surface of the electronic terminal.

15. A non-transitory computer-readable storage medium configured to store one or more instructions, that when executed by at least one processor of an electronic device, cause the at least one processor to:
receive a biometric feature signal;
sense a sliding track formed by a sliding operation on a display area of the electronic terminal during a period when the biometric feature signal is inputted; and
intercept an image surrounded by the sliding track.

16. The non-transitory computer-readable storage medium of claim 15, wherein the one or more instructions, when sensing of the sliding track, cause the at least one processor to determine whether a biometric feature represented by the received biometric feature signal corresponds to a predetermined feature representation,
wherein the sliding track formed by the sliding operation on the display area of the electronic terminal is sensed when the biometric feature represented by the received biometric feature signal corresponds to the predetermined feature representation.

17. The non-transitory computer-readable storage medium of claim 16, wherein the predetermined feature representation comprises at least one of a fingerprint feature representation or a heart rate feature representation.

18. The non-transitory computer-readable storage medium of claim 15, wherein the one or more instructions, when intercepting of the image surrounded by the sliding track, cause the at least one processor to determine whether a curve formed by the sliding track is a closed curve,
wherein, when the curve formed by the sliding track is a closed curve, an image surrounded by the closed curve is intercepted.

19. The non-transitory computer-readable storage medium of claim 18, wherein the one or more instructions, when intercepting of the image surrounded by the closed curve, cause the at least one processor to:
control the electronic terminal to enter a selection editing interface when the curve formed by the sliding track is a closed curve;
control to receive an input on a screen of the electronic terminal for the closed curve from a user;
adjust a position and a shape of the closed curve according to the received input; and
intercept an image surrounded by the closed curve on the screen of the electronic terminal.

20. The non-transitory computer-readable storage medium of claim 15, wherein the one or more instructions further cause the at least one processor to control the electronic terminal to enter an image editing interface and edit the intercepted image according to an interactive input of a user on the image editing interface.
